(19) United States
(12) Patent Application Publication
(10) Pub. No.: US 2010/0285783 A1
(43) Pub. Date: Nov. 11, 2010

(54) METHOD OF COMMUNICATING INFORMATION FOR SUBSCRIBERS OF PREPAID SERVICES

(76) Inventors: William Huguet, Velizy (FR); Famory Toure, Nozay (FR); Francois Reynes, Colomiers Cedex (FR)

Correspondence Address: Carmen Patti Law Group, LLC, One N. LaSalle Street, 44th Floor, Chicago, IL, 60602, US

(21) Appl. No.: 12/733,837

(22) PCT Filed: Sep. 26, 2008
(86) PCT No.: PCT/FR2008/051722

§ 371 Date: May 7, 2010

(30) Foreign Application Priority Data
Sep. 28, 2007 (FR) 0706821

(51) Int. Cl. H04M 3/42

(52) U.S. Cl. 455/414.1

(57) ABSTRACT

A method enabling a mobile communication terminal (1) belonging to an operator's network to access a service such as push mail, which method comprises a step of creating a request from the mobile communication terminal (1) intended for a payment server (2), a step of identifying that terminal (1) and the service requested by that terminal, a step of querying a user database (3) in order to determine whether the identified terminal benefits from prepayment for the requested service, and a step of sending the mobile terminal (1) at least one piece of information about the user's account for the requested prepaid service, the communication between the terminal (1) and the payment server (2) being carried out using an http(s) protocol, with the payment server (2) querying said database (3) and transmitting the information about the user's account in XML language.

The invention pertains to the technical field of telecommunications.

The invention particularly applies to communicating information intended to be viewed on a mobile communication terminal.

Prepaid services, for example “push mail”, have been developed, in particular for certain users of mobile terminals for whom the use of the terminal is controlled: children or employees using company terminals, for example.

A user of a prepaid service can only access the service after his or her account status has been checked. This account status must be updated in real time.

For example, the user sends a request to a Mobile Switching Center (MSC). The switching center then sends a request to a prepayment platform, which, in response, indicates whether the status of the user's account allows him or her to access the requested service. The requests and responses conventionally use the signaling protocol SS7. When the response is positive, the switching center connects the user to the requested service.

The document WO-2004/010393 describes a real-time prepaid service billing device, enabling access to platforms that use different SS7 protocols.

An anonymous prepaid Internet access method is disclosed in the document FR-2817056. This method makes it possible to make purchases over the Internet or view pay websites by debiting prepaid connection time corresponding to the amount of the purchase or viewing of the pay site.

The document WO 2007/001231 describes a 3GPP network comprising an AAA server making it possible to check, in real time, the credit remaining for accessing a prepaid service.

In the state of the art, several methods have been proposed to allow users of mobile terminals who have subscribed to prepaid services to be informed of their account balance or have a billing statement.

In a first approach, consumption information is provided by a WAP (Wireless Application Protocol) page. This approach is not satisfactory, given the limitations of WAP technology, in particular in terms of access speed. WAP services have not been as successful as expected (Hung et al, Critical factors of WAP services adoption: an empirical study, Electronic Commerce Research and Applications 2, 2003, pp. 42-60).

In a second approach, the user dials a specific number that allows him or her to refill his or her account. This approach is not satisfactory: only data about the account may be edited (such as an e-mail address).

In a third approach, the USSD (Unstructured Supplementary Service Data) standard of GSM terminals is used. For example, the company Orange offers terminal users the #123# service for billing tracking. This approach is not satisfactory: it depends on the operator and relies on an SS7 protocol.

In a fourth approach, billing tracking is carried out by the SMS (Short Message Service) messaging service This approach has the same drawbacks as using the USSD standard, with less interactivity.

It has also been proposed to use the STK (Sim Tool Kit) communication protocol.

The purpose of the invention is to provide ergonomic self-care tools for subscribers of prepaid services, as these tools ensure a high level of interactivity and enable subscribers to track their consumption, view their account balance, and edit their personal data in real time.

These self-care tools must make it possible to reduce the cost of managing subscribers of prepaid services. These tools must also lead to greater customer loyalty. The implementation of these tools must enable subscribers to track their consumption in real-time, without contacting a customer representative, without querying a voice server, and without using low-interactivity means (Web or WAP interface, e-mail).

To these ends, the invention, according to a first aspect, discloses a method enabling a mobile communication terminal belonging to an operator's network to access a service such as push mail, which method comprises a step of creating a request of the mobile communication terminal intended for a payment server, a step of identifying that terminal and the service requested by that terminal, a step of querying a user database in order to determine whether the identified terminal benefits from prepayment for the requested service, and a step of sending the mobile terminal at least one piece of information about the user's account for the requested prepaid service, the communication between the terminal and the payment server being carried out using an http(s) protocol, with the payment server querying said database and transmitting the information about the user's account in XML language.

Advantageously, the method comprises the step of editing at least one piece of data regarding the user's account, this step of editing comprising the user's terminal sending an http(s) request to the payment server.

Advantageously, the piece of data regarding the user's account is chosen from among a group comprising the user's e-mail address, a password, and the log of transactions carried out on the account (refilling, bonuses, consumptions).

The invention, according to a second aspect, discloses a communication system comprising a mobile communication terminal belonging to an operator's network, a payment server and a user database, the terminal comprising means of creating a request intended for said payment server, the server comprising means of identifying that terminal and a prepaid service requested by that terminal, the server further comprising means of querying the user database in order to determine whether the identified terminal benefits from prepayment for the requested service, the server comprising means for sending the mobile terminal at least one piece of information about the user's account for the requested prepaid service, the communication between the terminal and the payment server being carried out using an http(s) protocol, with the payment server querying said database and transmitting the information about the user's account in XML language.

The invention, according to a third aspect, discloses a computer program product intended to be stored in the memory of a mobile communication terminal and/or stored on a memory medium that may be read by a mobile terminal's reader, and/or downloadable onto a mobile communication terminal via a remote server, this program containing instructions for the implementation of the method presented above.

Other objects and advantages of the invention will become apparent upon reading the description below of currently preferred embodiments. This description makes reference to the attached drawing, which is a schematic view of a session scenario between a communication terminal, a payment server, and a user database.

The subscriber's terminal 1 is, for example, a mobile terminal equipped with e-mail features, for example the type sold under the brand name Blackberry Pearl.

This terminal 1 establishes a communication session with a payment server 2. This session is established by an HTTP GET request.

An example request is given below:
http(s)://server2/method=val1&parameter1=val2 . . . &parametern=vain

The payment server 2 queries a user database 3, or an event database 4.

The server 2 transforms the data obtained by the bases 3, 4 in order to send them in a format supported by the terminal 1.

The server's 2 responses are obtained in XML language (eXtensible Markup Language).

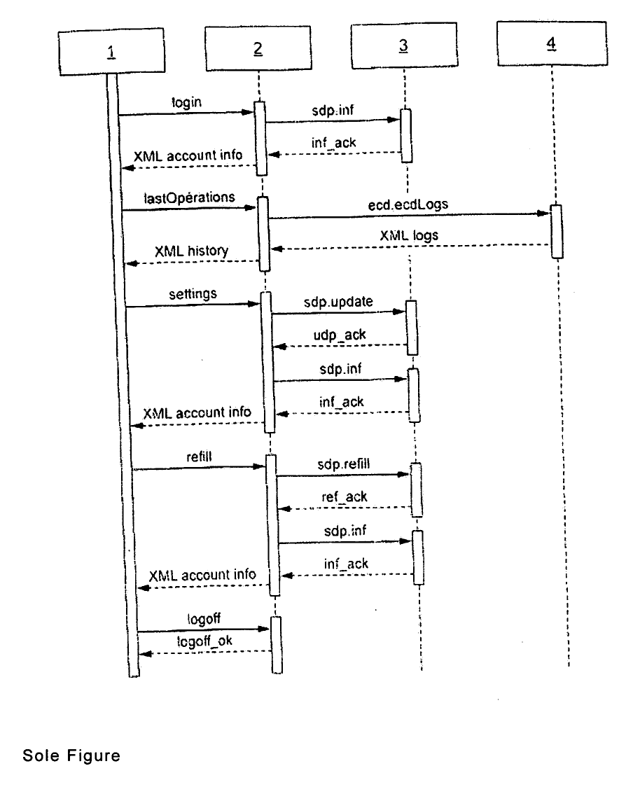

An example scenario is given in FIG. 1.

A session is created by the message
method=login&msisdn=val1&password=val2

An XML character string is obtained in response.

<inobj_inf_ack>

<rbonusin>Bonus information</rbonusin>
<rcurstat>Account status (Active, Inactive,
Deactivated)</rcurstat>
<remail>Email address</remail>
<rmsisdn>MSISDN</rmsisdn>
<rpwdtot>Number of wrong password attempts</rpwdtot>
<rremainc>Remaining credit</rremainc>
<rtmc>End of activity period</rtmc>
<rtr>End of validity period</rtr>
<status_a>Account status (validated, activated,
exhausted, etc)</status_a>
<status_r> Request status (OK, NOK)</status_r>

</inobj_inf_ack>

To change an e-mail address or password, the terminal 1 sends the following message.
method=settings&msisdn=val1[&email=val2][&password=val3&confirm=val4]

An XML character string is obtained in response.
inobj_inf_ack.

To refill an account, the terminal sends the following message.
method=refill&msisdn=val1&scratch=val2

An XML character string is obtained in response:
inobj_inf_ack

In order to track consumption (latest transactions, refills, bonuses), the following message is sent by the terminal.
method=lastOperations&msisdn=val1

An XML character string is obtained in response:

<History>

<cdr>

<date>Date of the transaction</date>
<credit>Remaining credit</credit>
<gprs_data_volume>GPRS data volume
consumed</gprs_data_volume>
<scratch_card_number>Scratch card used for
the refill

operation</scratch_card_number>

<main_amount1>Amount refilled on the main
account</main_amount1>
<emiles>Bonus allocated</emiles>

</cdr>

</History>

To close the session, the following message is sent by the terminal.
method=logoff&msisdn=val1

The invention has several upsides.

First, the installation of a self-care application embedded within the communication terminal makes it possible to bypass the properties of the operator's network for tracking the consumption of services.

Additionally, only information that is actually relevant is displayed on the terminal, with adaptations tailored to that terminal's performance (particularly screen size). Helpful information is therefore obtained more quickly and more legibly than by implementing earlier techniques, in particular WAP.

Installing a program embedded within the communication terminal enables the operator to offer easier-to-use services. For example, whenever the subscriber wishes to refill his or her account, he or she may use his or her credit card, whose number is saved in the terminal.

1. A method enabling a mobile communication terminal (1) belonging to an operator's network to access and edit data about an account within a prepaid service supported by said network, which method comprises a step of creating a request from the mobile communication terminal (1) intended for a payment server (2), a step of identifying that terminal (1) and the service requested by that terminal, a step of querying a user database (3) in order to determine whether the identified terminal benefits from prepayment for the requested service, and a step of sending the mobile terminal (1) at least one piece of information about the user's account for the requested prepaid service, the communication between the terminal (1) and the payment server (2) being carried out using an http(s) protocol, with the payment server (2) querying said database (3) and transmitting the information about the user's account in XML language.

2. A method according to claim 1, characterized in that it comprises a step of editing at least one piece of data regarding the user's account, which step of editing comprises the user's terminal (1) sending an http(s) request to the payment server.

3. A method according to claim 2, characterized in that the piece of data regarding the user's account is chosen from among the group comprising the user's e-mail address, a password, and the log of transactions carried out on the account.

4. A communication system, comprising a mobile communication terminal (1) belonging to an operator's network, a payment server (2) and a user database (3), which system is characterized in that the terminal (1) comprises means of creating a request intended for said payment server (2), the server (2) comprising means of identifying that terminal and a prepaid service requested by that terminal, the server (2) further comprising means of querying the user database (3) in order to determine whether the identified terminal benefits from prepayment for the requested service, the server (2) comprising means for sending the mobile terminal (1) at least one piece of information about the user's account for the requested prepaid service, the communication between the terminal and the payment server (2) being carried out using an HTTP protocol, with the payment server (2) querying said database (3) and transmitting the information about the user's account in XML language.

5. A computer program product intended to be stored in the memory of a mobile communication terminal and/or stored on a memory medium that may be read by a mobile terminal's reader, and/or downloadable onto a mobile communication terminal via a remote server, this program containing instructions for the implementation of the method according to one of the claims 1 to 3.
